(19) United States
(12) Patent Application Publication
(10) Pub. No.: US 2008/0297316 A1
(43) Pub. Date: Dec. 4, 2008

(54) Method and Rfid Reader for Communication Via Radio Channel

(75) Inventors: Michael Rauber, Passail (AT); Daniel Arnitz, Graz-Liebenau (AT)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/097,576

(22) PCT Filed: Dec. 6, 2006
(86) PCT No.: PCT/IB06/54628

§ 371 Date: Jun. 16, 2008

(30) Foreign Application Priority Data
Dec. 14, 2005 (EP) 05112093.9

(51) Int. Cl. H04Q 5/22; H04L 1/00

(52) U.S. Cl. 340/10.1; 370/252

(57) ABSTRACT

A method of communication between an RFID reader (1) and a plurality of transponders (2a, 2b) via a radio channel (20) is disclosed. The method comprises the steps of measuring a noise level (SN) of the radio channel (20), selecting an error correction algorithm (ECA1, ECA2, . . . ECAx) depending on the result of the noise level (SN) measurement, and setting both the RFID reader (1) and the transponders (2a, 2b) to the selected error correction algorithm. Furthermore, an RFID reader (1) is disclosed, which is adapted to perform the method according to the invention.

### FIELD OF THE INVENTION

The invention relates to a method of communication between an RFID reader and transponders via a radio channel.

The invention further relates to an RFID reader being adapted to communicate with transponders via a radio channel.

### BACKGROUND OF THE INVENTION

Digital communication systems utilize communication channels through which traffic data is communicated. These channels are typically bandwidth-limited and have a finite channel capacity. Together with other properties of the channel, such as various forms of noise and interference, the channel capacity will cause, or otherwise result with statistical certainty in the injection of error conditions in the traffic data communicated via the channel. The effects of these error conditions are particularly evident in wireless communication systems, such as RFID systems, which utilize generally unpredictable over-the-air communication channels (radio channels) through which remote stations, such as RFID transponders, communicate with a central station, such as an RFID reader station.

A first approach to eliminate or at least reduce the effects of these error conditions is to add checksums to the traffic data at the sending station and to carry out cyclic redundancy checks (CRC) at the receiving station. If the CRC reveals that the received data contain errors, they are discarded. In other words, only error-free received data are evaluated and further processed by the receiving station. In the case of erroneous data, the receiving station has to inform the sending station about the occurred error and requests the sending station to re-transmit these data, which results in reduced transmission rates.

In order to eliminate the necessity of discarding erroneous data, error-correcting algorithms are utilized in a second approach. However, the use of error correction algorithms does not come without costs to the communication system. All error correction algorithms have the common feature that they add additional redundant data for error recognition and error correction to the traffic data which are to be transmitted. As a result, there is an overhead of redundant data that is also transmitted through the communication channel, thereby reducing the bandwidth available for the transmission of traffic data. This reduced traffic data transmission rate generally reduces the communication data rate. Particularly, it seriously affects the processing speed of anti-collision algorithms in RFID systems. Thus, under certain conditions, a better traffic data transmission rate can be achieved if no error correction algorithm is employed. Specifically if the communication channel is little or not disturbed, it is a better strategy to accept that data have to be discarded sporadically and re-transmitted than to accept a continuous reduction of traffic data bandwidth caused by the transmission of redundant error correction data.

Consequently, there is a need for a communication system which employs error correction algorithms that maximize the amount of traffic data transmitted between a central station, such as an RFID reader, and remote stations, such as transponders.

Document U.S. Pat. No. 6,314,535 B1 describes a method of mitigating the problem explained above. According to this method, an initial error correction algorithm is chosen and a first plurality of traffic data coded in packets that also contain the redundant error correction data are transmitted via the communication channel between a first and a second communication terminal. The error rate level of the communication channel is determined during the first multi-packet transmission. The error rate level of the communication channel may be determined by such techniques, e.g. measuring the number of defective corrected data packets. A subsequent error correction algorithm is selected from the plurality of error correction algorithms based upon the determined error rate level.

While the known method successfully makes use of the fact that the overhead of error correction data widely varies among different error correction algorithms, wherein, as a rule of thumb, the amount of redundant error correction overhead increases with the strength of the error correction algorithm, the known method has, however, shown the disadvantage that, in an initial phase of communication between the first and the second communication terminal, the initially chosen error correction algorithm may be completely inappropriate for the present quality of the communication channel. The reason is that this known dynamic adaptation of error correction algorithms is a trailing procedure requiring a number of “test” data packets to be sent through the communication channel, until the error level rate can be determined. In the further course of communication between the two communication terminals, this transient time until the method yields a useful result is of minor importance, but especially for inventory procedures in RFID systems, wherein an RFID reader has to find out how many and which transponders are in its communication range, this transient time is not acceptable, because most of the communication between the RFID reader and the transponders takes place in this initial inventory procedure, particularly caused by anti-collision algorithms that are necessary to reliably identify the transponders. After the transponders have been identified, they are “sent to sleep” by the RFID reader, so there is little subsequent communication between the transponders and the RFID reader. Consequently, there is still a need for a dynamic adaptation of error correction algorithms that are particularly effective in an initial phase of communication between an RFID reader and transponders via a radio channel. Particularly, such a solution should achieve useful results also in an initial phase of communication.

### OBJECT AND SUMMARY OF THE INVENTION

It is an object of the invention to provide a method of the type defined in the opening paragraph and an RFID reader of the type defined in the second paragraph, in which the disadvantages defined above are avoided.

The object of the invention is achieved by a method of communication between an RFID reader and transponders via a radio channel, the method comprising the steps of:
measuring a noise level of the radio channel,
selecting an error correction algorithm depending on the result of the noise level measurement, and
setting both the RFID reader and the transponders to the selected error correction algorithm.

Furthermore, the object of the invention is achieved by an RFID reader being adapted to communicate with transponders via a radio channel, the RFID reader comprising:
noise level measuring means for measuring a noise level of the radio channel, and
error correction algorithm selection means for selecting an error correction algorithm depending on the result of the noise level measurement, wherein the RFID reader is adapted to set itself to the selected error correction algorithm and to transmit selection information about the selected error correction algorithm to the transponders.

The characteristic features according to the invention provide the advantage that an appropriate type of error correction algorithm can already be selected at the beginning of communication between the RFID reader and the transponders, depending on the noise level measurement. While this first “guess” of a type of error correction algorithm may still not represent the optimal result, it nevertheless provides a good starting point for applying error correction. In the further process of communication between the RFID readers and the transponders, the error correction algorithm can be quickly adapted in dependence on further noise level measurements. As a result, the present invention does not have the effect of a “transient time”, or at least shows a reduced “transient time” as compared with the known systems and method. The known method only works appropriately when a sufficient number of “test” traffic data packets have been transmitted through the communication channel and evaluated in respect of their error rate level. The present invention also provides synergetic effects, as the measured noise level of the radio channel can also be used to set various parameters of the RFID system, such as detection thresholds, etc.

The term “noise level measuring” as used in this text does not only comprise measuring instantaneous values of the noise level, but also comprises recording noise level values and evaluating their course over time (or within a time window). The term “noise level measuring” also comprises carrying out measurements of the noise level in a plurality of distinct frequency bands and evaluating the results of these distinct measurements. By applying these noise level measurements, different types of noise and interference, respectively, can be discriminated.

It is advantageous if the steps of measuring the noise level and selecting an error correction algorithm are carried out in the RFID reader, wherein the RFID reader transmits selection information about the selected error correction algorithm to the transponders. In doing so, the advantage is obtained that necessary hardware adaptations or additions in order to implement the invention merely concern the RFID reader, whereas the transponders that are produced in a much higher number than the RFID reader can still have a very cheap layout.

Furthermore, it is advantageous if the step of selecting an error correction algorithm comprises selecting a stronger error correction algorithm in the case of a higher noise level or in the case of a noise level course, which is either unstable or has a tendency towards higher noise levels, and selecting a weaker error correction algorithm in the case of a lower noise level or in the case of a noise level course, which has a tendency towards lower noise levels. In this way, the advantage is obtained that the error correction algorithm to be used corresponds to the quality of the radio channel. The term “stronger” error correction algorithm as used herein designates an error correction algorithm that is capable of correcting a higher portion of erroneous data in a data frame or data package than a “weaker” error correction algorithm.

In yet another advantageous method, the step of selecting an error correction algorithm comprises using or not using an error correction algorithm. Accordingly, the advantage is obtained that, in the case of high-quality radio channels, the error correction algorithm is completely switched off in order to transmit a maximum of traffic data, whereas the error correction algorithm is switched on in the case of low-quality radio channels. It should be noted that switching on an error correction algorithm can be combined with selecting an error correction algorithm from a plurality of different error correction algorithms.

Finally, it is advantageous if an error rate level of the radio channel is determined and taken into account for selecting an error correction algorithm. In doing so, the advantage is obtained that information about statistical error information, such as the error level rate, can be additionally taken into account for selecting the best error correction algorithm when the error correction algorithms which automatically supply this information are processed in the course of communication between the RFID reader and the transponders.

These and other aspects of the invention are apparent from and will be elucidated with reference to non-limiting examples described hereinafter.

### BRIEF DESCRIPTION OF THE DRAWINGS

In the drawings,

FIG. 1 is a schematic block circuit diagram of an RFID system according to the invention.

FIG. 2 is a schematic block circuit diagram of an RFID transponder employed in the present invention.

### DESCRIPTION OF EMBODIMENTS

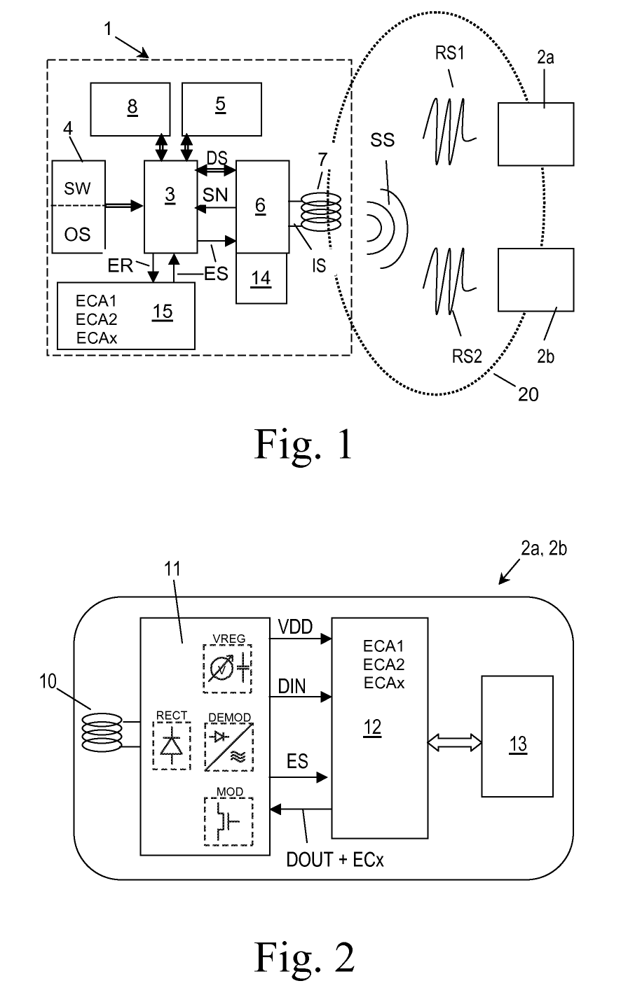

FIG. 1 is a schematic block circuit diagram of an RFID (Radio Frequency Identification) system comprising an RFID reader 1 and a number of RFID transponders 2a, 2b, wherein, for the sake of clarity, only two RFID transponders are depicted. RFID reader 1 communicates with the RFID transponders 2a, 2b in a contactless manner via a communication channel in the form of a radio channel 20 by means of modulated electromagnetic signals. The RFID reader 1 comprises control means 3, such as a microprocessor or microcontroller, which control means 3 communicate with program storage means 4 via a data bus. The program storage means 4 are adapted to store an operating system OS for basic operation of the control means 3 and an application program code SW to be processed by the control means 3. The program storage means 4 may be configured as a non-volatile memory, such as a PROM, EPROM, EEPROM or the like. The program storage means 4 may also be configured as a user-definable ASIC, PAL or the like. Furthermore, the control means 3 and the program storage means 4 may be integrated in a single chip. It should be noted that the application program code SW and the operating system OS may be mutually integrated. The control means 3 further communicate with a random-access memory 5. When processing the program code SW, the control means 3 cooperate with input/output means 8, which can be configured e.g. as a link interface to a computer. The control means 3 further communicate with radio frequency communication means 6 which are connected to an antenna 7 for transmitting electromagnetic signals SS to the RFID transponders 2a, 2b. These electromagnetic signals SS may be used for transmitting data and instructions to the RFID transponders 2a, 2b and for energizing the RFID transponders 2a, 2b if they are configured as passive transponders. The RFID transponders 2a, 2b respond to the RFID reader with response signals RS1, RS2. Data exchange between the RFID reader 1 and the RFID transponders 2a, 2b may be accomplished by standard data transmission protocols and standard modulation methods. For instance, the electromagnetic signal SS sent from the RFID reader 1 to the RFID transponders 2a, 2b is configured as a pulsewidth-modulated signal. The response signals RS1, RS2 from the RFID transponders 2a, 2b to the RFID reader are e.g. load-modulated signals, wherein a carrier signal or subcarrier signal contained in the electromagnetic signal SS is modulated by switching a load impedance connected to the antennas of the RFID transponders 2a, 2b, so that varying energy is drawn from the carrier signal or subcarrier signal. Switching the load impedances at the RFID transponders causes a change of the impedance of the antenna 7 of the RFID reader 1 and hence a varying amplitude of the voltage at the antenna 7 of the RFID reader 1, which varying voltage amplitude represents an input signal IS to the radio frequency communication means 6. For recovery of data contained in the input signal IS, the input signal IS is rectified or demodulated by radio frequency communication means 6, yielding data stream signal DS. The control means 3 extract the data coded in the data stream signal DS, e.g. by comparing it with defined bit levels, and carry out an error correction algorithm, if set to do so.

According to the invention, the RFID reader 1 is provided with noise level measuring means 14 being adapted to measure a noise level SN of the radio channel 20. In this embodiment of the invention, the noise level measuring means 14 are incorporated in the radio frequency communication means 6, but they may also be incorporated in other parts of the RFID reader 1, such as the control means 3, or configured as an independent component within the RFID reader 1. Noise level measuring can be carried out, for instance, by calculating expectation values or the standard deviation. Noise level measuring can also be carried out by recording noise level values and evaluating their course over time (or within a time window), or by measuring the noise level in a plurality of distinct frequency bands and evaluating the results of these distinct measurements.

The noise level measuring means 14 pass on the measured noise level SN to the control means 3. The control means 3 correspond to error correction algorithm selection means 15 being adapted to select an error correction algorithm ECA1, ECA2 to ECAx depending on the noise level SN. Selecting an appropriate error correction algorithm means either switching on an error correction algorithm when the radio channel 20 has a low quality, i.e. when the noise level SN is high, or switching off an error correction algorithm when the noise level SN is low. When the value of the noise level SN requires an error correction algorithm to be used, it is also possible to select the best suitable error correction algorithm from various different error correction algorithms, wherein stronger error correction algorithms are selected with increased noise level SN, and vice versa.

Having selected an appropriate error correction algorithm, the error correction algorithm selection means 15 configure the control means 3 to use the selected error correction algorithm in the further communication with the transponders 2a, 2b. The error correction algorithm selection means 15 further instruct the control means 3 to send selection information ES to the transponders 2a, 2b so as to inform them which error correction algorithm they have to use in the further communication with the RFID reader 1.

The steps of measuring the noise level SN, selecting an appropriate error correction algorithm depending on the measured noise level, and setting both the RFID reader 1 and the transponders 2a, 2b to use the selected error correction algorithm are cyclically repeated so that a continuous dynamic adaptation of the RFID system to the best error correction algorithm for the present quality of the radio channel 20 is carried out.

In order to establish communication with the transponders 2a, 2b, the control means 3 carry out an anti-collision algorithm employing the selected error correction algorithm. Information about the error rate level ER of the radio channel 20 is gathered automatically by processing the error correction algorithm. This error rate level ER is supplied to the error correction algorithm selection means 15 which take it into account for selecting the best suitable error correction algorithm.

FIG. 2 is a schematic block circuit diagram of an embodiment of the RFID transponders 2a, 2b. It should be noted that the configuration of the RFID transponders 2a, 2b is merely an example for the sake of understanding the present invention, and it will be evident to those skilled in the art that this configuration may be varied. Each RFID transponder 2a, 2b is configured as a passive transponder and comprises an antenna 10, an analog radio frequency interface 11 connected to the antenna 10, a digital control unit 12 connected to the analog radio frequency interface 11, and a memory 13 connected to the digital control unit 12. The memory 13 is a non-volatile memory, such as an EEPROM, so that data written into the memory 13 during communication with the RFID reader 1 remain stored, even when the RFID transponder 2a, 2b is switched off, e.g. because it leaves the transmitting range of the RFID reader 1 and is therefore no longer energized by the RFID reader 1. Memory 13 may also contain a program code for operating the digital control unit 12 and a unique identification number. Antenna 10 receives the electromagnetic signals SS from the RFID reader 1 and passes them on to the analog radio frequency interface 11. In general, the analog radio frequency interface 11 comprises a rectifier RECT and a voltage regulator VREG with integrated energy storage element, such as a capacitor, to derive the necessary operating voltage VDD for the digital control unit 12 and the memory 13 from the received electromagnetic signals SS. Furthermore, analog radio frequency interface 11 comprises a demodulator DEMOD for extracting input traffic data DIN and selection information ES from the electromagnetic signals SS and for passing them on to the digital control unit 12. The term “traffic data” as used herein is to be understood in the sense of useful data that are exchanged between the RFID reader and the transponders 2a, 2b and may contain instructions, identification data and the like. Digital control unit 12 processes the received input traffic data DIN and may respond to the RFID reader 1 by creating output traffic data DOUT. Digital control unit 12 also evaluates the selection information ES and selects an error correction algorithm ECA1, ECA2 to ECAx in accordance with the received selection information ES. When creating output traffic data DOUT, the digital control unit 12 adds necessary redundant error correction data ECx in accordance with the selected error correction algorithm and packs both the output traffic data DOUT and the redundant error correction data ECx into data frames or data packets.

The data frames or data packets containing the output traffic data DOUT, together with the redundant error correction data ECx, are then passed on to the analog radio frequency interface 11. Analog radio frequency interface 11 comprises a modulator MOD that modulates the output data DOUT and transmits the modulated signals as response signals RS1, RS2 via antenna 10 through the radio channel 20 to the RFID reader 1.

It should be noted that, instead of coding the output traffic data DOUT with error correction data ECx in the control unit 12, it is also possible to store certain output traffic data in the memory 13 in pre-coded forms in accordance with the various error correction algorithms. Such an embodiment would allow the use of existing types of transponders for the present invention, particularly if the output traffic data only consist of few different data. Of course, this suggestion comes along with some “waste” of memory. Furthermore, existing types of transponders will transmit an identification number in an uncoded form.

It will be evident that selecting an error correction algorithm also means selecting cycling redundancy checks, as this is also a kind of error correction.

Furthermore, it should be noted that the entities shown in the Figures have a functional rather than a physical meaning. Thus, in reality, a shown entity may be distributed over more physical entities and, in reality, one physical entity may comprise more functional entities. Accordingly, a realization of a reader 1 or of transponders 2a, 2b does not necessarily reflect the shown separation of blocks.

Moreover, those skilled in the art will easily understand that the invention is not limited to RFID systems or smart card systems, even though the Figures show just one illustrative example of application of the invention. The invention rather applies to a variety of sender/receiver systems, which carry out data transmission by means of radio waves, sound, and/or light. Furthermore, the invention is not limited to radio links, but also covers data transmissions via wires and optical fibers.

Finally, it should be noted that the above-mentioned embodiments illustrate rather than limit the invention, and that those skilled in the art will be capable of designing many alternative embodiments without departing from the scope of the invention as defined in the appended claims. In the claims, any reference signs placed in parentheses shall not be construed as limiting the claims. Use of the verb “comprise” and its conjugations does not exclude the presence of elements or steps other than those stated in any claim or the specification as a whole. The singular reference of an element does not exclude the plural reference of such elements, and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A method of communication between an RFID reader and transponders via a radio channel, the method comprising the steps of:
measuring a noise level of the radio channel,
selecting an error correction algorithm depending on the result of the noise level measurement, and
setting both the RFID reader and the transponders to the selected error correction algorithm.

2. The method of claim 1, wherein the steps of measuring the noise level and selecting an error correction algorithm are carried out in the RFID reader, wherein the RFID reader transmits selection information about the selected error correction algorithm to the transponders.

3. The method of claim 1, wherein the step of selecting an error correction algorithm comprises selecting a stronger error correction algorithm in the case of a higher noise level or in the case of a noise level course, which is either unstable or has a tendency towards higher noise levels, and selecting a weaker error correction algorithm in the case of a lower noise level or in the case of a noise level course, which has a tendency towards lower noise levels.

4. The method of claim 1, wherein the step of selecting an error correction algorithm comprises using or not using an error correction algorithm.

5. The method of claim 1, wherein an error rate level of the radio channel is determined and taken into account for selecting an error correction algorithm.

6. An RFID reader being adapted to communicate with transponders via a radio channel, the RFID reader comprising:
noise level measuring means for measuring a noise level of the radio channel, and
error correction algorithm selection means for selecting an error correction algorithm depending on the result of the noise level measurement, wherein the RFID reader is adapted to set itself to the selected error correction algorithm and to transmit selection information about the selected error correction algorithm to the transponders.

7. The RFID reader of claim 6, wherein the error correction algorithm selection means are adapted to select a stronger error correction algorithm in the case of a higher noise level or in the case of a noise level course, which is either unstable or has a tendency towards higher noise levels, and to select a weaker error correction algorithm in the case of a lower noise level or in the case of a noise level course, which has a tendency towards lower noise levels.

8. The RFID reader of claim 6, wherein the error correction algorithm selection means are adapted to select between using or not using an error correction algorithm.

9. The RFID reader of claim 6, being adapted to determine an error rate level of the radio channel, wherein the error correction algorithm selection means are adapted to take into account the error rate level for selecting an error correction algorithm.
